(19) United States
(12) Patent Application Publication
(10) Pub. No.: US 2023/0264698 A1
(43) Pub. Date: Aug. 24, 2023

(54) DRIVE PLANNING DEVICE, STORAGE MEDIUM STORING COMPUTER PROGRAM FOR DRIVE PLANNING AND DRIVE PLANNING METHOD

(71) Applicant: TOYOTA JIDOSHA KABUSHIKI KAISHA, Toyota-shi (JP)

(72) Inventors: Jumpei KIRIKI, Tokyo-to (JP); Taiyo UEJIMA, Tokyo-to (JP)

(73) Assignee: TOYOTA JIDOSHA KABUSHIKI KAISHA, Toyota-shi (JP)

(21) Appl. No.: 18/141,684

(22) Filed: May 1, 2023

Related U.S. Application Data
(62) Division of application No. 17/363,759, filed on Jun. 30, 2021.

(30) Foreign Application Priority Data
Jul. 1, 2020 (JP) 2020-113939

(51) Int. Cl. B60W 40/08; B60W 30/08

(52) U.S. Cl. CPC B60W 40/08; B60W 30/08; B60W 2554/4041

(57) ABSTRACT

A drive planning device has a processor configured to assess whether or not there is a problem with the driver and to assess whether or not a predetermined condition has been met based on information for the surrounding environment of a vehicle, and to create a first driving plan in which the vehicle is moved to the shoulder and stopped when it has been assessed that there is a problem with the driver and the predetermined condition has been met, or to create a second driving plan in which the vehicle is stopped in the traffic lane in which the vehicle is traveling when it has been assessed that there is a problem with the driver and the condition assessment unit has assessed that the predetermined condition has not been met.

### CROSS REFERENCE TO RELATED APPLICATION

This application is a divisional of U.S. 17/363,759, filed Jun. 30, 2021, which is based on and claims priority to Japanese Patent Application No. 2020-113939, filed on Jul. 1, 2020, the disclosure of which is incorporated by reference herein in its entirety.

### FIELD

The present invention relates to a drive planning device, to a storage medium that stores a computer program for drive planning, and to a drive planning method.

### BACKGROUND

An automatic control device mounted in a vehicle creates a traveling route for the vehicle based on the current location of the vehicle, the destination location of the vehicle, and map information, and controls the vehicle so that it travels along the traveling route.

The automatic control device controls operation of the vehicle so that a safe distance is maintained between the vehicle and other vehicles. When a safe distance cannot be maintained between the vehicle and another vehicle by automatic control, operation of the vehicle is switched from automatic control to manual control, transferring control of the vehicle to the driver.

When there is a problem with the driver, the automatic control device controls the vehicle so that it stops on the traffic lane in which it is traveling. This is because in such a situation it is no longer possible to switch operation of the vehicle from automatic control to manual control to transfer control of the vehicle to the driver when a safe distance cannot be maintained between the vehicle and another vehicle by automatic control.

Japanese Unexamined Patent Publication No. 2014-58229, for example, proposes a technique in which, when it has been assessed that there is a problem with the driver, tracking control of another vehicle ahead which is traveling in front of the vehicle is automatically initiated based on surrounding information that includes information for the vehicle ahead, and the vehicle is stopped while also completing tracking control, when stopping information has been obtained for the vehicle ahead while tracking control is active.

### SUMMARY

However, stopping the vehicle on the traffic lane in which other vehicles are also traveling can potentially result in collision with the other vehicles that approach from behind.

When there is a problem with the driver, therefore, it may be considered preferable to stop the vehicle after moving it to the shoulder which is presumably a safe location where other vehicles are not traveling.

However, since travel of vehicles is permitted on the shoulder depending on the location and the time of day, it cannot be assumed that the shoulder is always a safe location where other vehicles are not traveling.

It is therefore an object of the present invention to provide a drive planning device that creates a driving plan for the vehicle so that the vehicle is moved to the shoulder and stopped, when there is a problem with the driver, only if a predetermined condition has been met that are estimated to allow the safety of the vehicle to be ensured.

One embodiment of the invention provides a drive planning device. The drive planning device has a driver assessment unit that assesses whether or not there is a problem with the driver, a condition assessment unit that assesses whether or not a predetermined condition has been met based on information for the surrounding environment of the vehicle and a drive planning unit that creates a first driving plan in which the vehicle is moved to the shoulder and stopped when the driver assessment unit has assessed that there is a problem with the driver and the condition assessment unit has assessed that the predetermined condition has been met, or creates a second driving plan in which the vehicle is stopped in the traffic lane in which the vehicle is traveling when the driver assessment unit has assessed that there is a problem with the driver and the condition assessment unit has assessed that the predetermined condition has not been met.

In this drive planning device, it is preferred that the condition assessment unit assesses that the predetermined condition has been met when the vehicle is traveling in a traffic lane bordering the shoulder and no other objects are detected traveling on the shoulder from behind the vehicle and approaching the vehicle.

In this drive planning device, it is preferred that the condition assessment unit assesses that the predetermined condition has not been met when at least one other object is detected traveling on the shoulder from behind the vehicle and approaching the vehicle.

In this drive planning device, it is preferred that the drive planning unit creates a first driving plan so that the vehicle is moved to the shoulder and stopped after the vehicle has been moved to the shoulder side in the traffic lane in which the vehicle is traveling and has traveled a predetermined distance along the shoulder.

In this drive planning device, it is preferred that the drive planning unit creates a third driving plan for movement and travel of the vehicle to the shoulder side in the traffic lane in which the vehicle is traveling when the driver assessment unit has assessed that there is a problem with the driver, and after the third driving plan has been created, the condition assessment unit creates the first driving plan or second driving plan according to the assessment of whether or not the predetermined condition has been met.

According to another embodiment, a computer-readable non-transitory storage medium is provided which stores a computer program for drive planning. The computer program for drive planning causes a processor to assess whether or not there is a problem with the driver to assess whether or not a predetermined condition has been met based on information for the surrounding environment of the vehicle and to create a first driving plan in which the vehicle is moved to the shoulder and stopped when it has been assessed that there is a problem with the driver and the predetermined condition has been met, or create a second driving plan in which the vehicle is stopped in the traffic lane in which the vehicle is traveling when it has been assessed that there is a problem with the driver and it has been assessed that the predetermined condition has not been met.

Another embodiment of the invention provides a drive planning method. In the drive planning method, a drive planning device executes to assess whether or not there is a problem with the driver to assess whether or not a predetermined condition has been met based on information for the surrounding environment of the vehicle and to create a first driving plan in which the vehicle is moved to the shoulder and stopped when it has been assessed that there is a problem with the driver and the predetermined condition has been met, or create a second driving plan in which the vehicle is stopped in the traffic lane in which the vehicle is traveling when it has been assessed that there is a problem with the driver and it has been assessed that the predetermined condition has not been met.

The drive planning device of the invention can create a driving plan for the vehicle so that the vehicle is moved to the shoulder and stopped when there is a problem with the driver, only if a predetermined condition has been met that is estimated to allow the safety of the vehicle to be ensured.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1A is a diagram showing operation of the drive planning device of a first embodiment in overview.

FIG. 1B is a diagram showing operation of the drive planning device of a first embodiment in overview.

FIG. 2 is a general schematic drawing of a vehicle in which a drive planning device of the first embodiment is mounted.

FIG. 3 is an operation flow chart for the drive planning device of the first embodiment.

FIG. 4 is an operation flow chart for a condition assessment unit.

FIG. 5A is a diagram showing operation of a vehicle controlled based on a driving plan.

FIG. 5B is a diagram showing operation of a vehicle controlled based on a driving plan.

FIG. 6 is an operation flow chart for the drive planning device according to a second embodiment.

FIG. 7A is a diagram showing operation of a vehicle controlled based on a driving plan.

FIG. 7B is a diagram showing operation of a vehicle controlled based on a driving plan.

### DESCRIPTION OF EMBODIMENTS

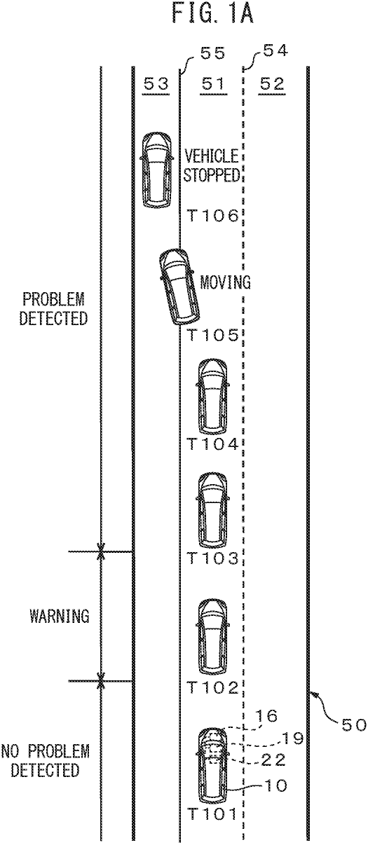

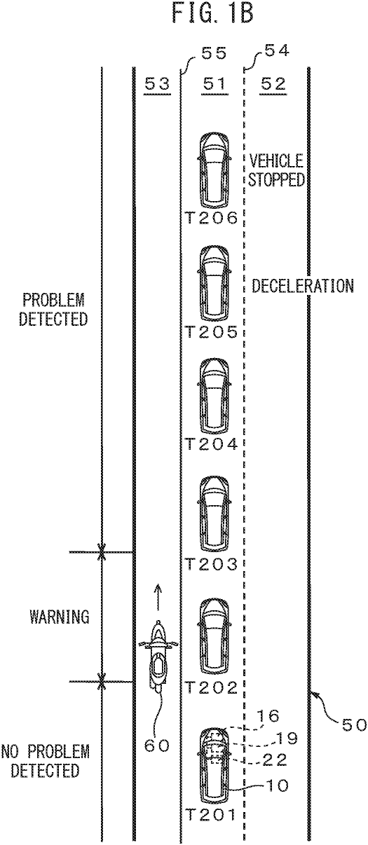

FIG. 1A and FIG. 1B are diagrams showing operation of a drive planning device according to the first embodiment in overview. Operation of the drive planning device disclosed herein will now be described in overview with reference to FIG. 1A and FIG. 1B.

In the examples shown in FIG. 1A and FIG. 1B, the vehicle 10 travels on a traffic lane 51 bordering a shoulder 53 on a road 50, the road 50 having two traffic lanes 51, 52 and a shoulder 53. The two traffic lanes 51 and 52 are divided by a lane marking line 54, and the traffic lane 51 and shoulder 53 are divided by a division line 55. In the vehicle 10 there are mounted a monitoring device 16 for detection of driver problems, a drive planning device 22 that creates a driving plan after having assessed that the driver has a problem, and an object detector 19 that detects objects approaching the vehicle 10 from behind the vehicle 10.

Assessment has been made by the drive planning device 22 that there is a problem with the driver at time T103 in the example shown in FIG. 1A and at time T203 in the example shown in FIG. 1B, but the subsequent driving plan differs depending on the surrounding environment information. Trouble with the driver is detected by the monitoring device 16, and when activity related to operation by the driver is not detected after alerting the driver, then the drive planning device 22 assesses that there is a problem.

In the example shown in FIG. 1A, at time T103, the vehicle 10 is traveling on the traffic lane 51 bordering the shoulder 53, and since the object detector 19 does not detect any object traveling on the shoulder and approaching the vehicle 10 from behind the vehicle 10, the drive planning device 22 assesses that the predetermined condition has been met. Since the predetermined condition has been met at time T104, the drive planning device 22 of the vehicle 10 creates a driving plan for moving the vehicle 10 to the shoulder 53 and stopping it, and as a result the vehicle 10 changes traffic lanes at time T105 and stops on the shoulder at time T106.

In the example shown in FIG. 1B, on the other hand, at time T203, the vehicle 10 is traveling on the traffic lane 51 bordering the shoulder 53 but the object detector 19 detects another vehicle 60 traveling on the shoulder and approaching the vehicle 10 from behind the vehicle 10, and therefore the drive planning device 22 assesses that the predetermined condition has not been met. Since the predetermined condition has not been met at time T204, the drive planning device 22 of the vehicle 10 creates a driving plan for stopping the vehicle 10 not on the shoulder 53 but in the traffic lane 51 on which it is traveling, and as a result the vehicle 10 decelerates at time T205, coming to a halt in the traffic lane 51 at time T206.

Thus, the drive planning device 22 creates a driving plan for the vehicle so that the vehicle 10 is moved to the shoulder and stopped when there is a problem with the driver, only if predetermined condition has been met that are estimated to allow the safety of the vehicle 10 to be ensured, as explained above.

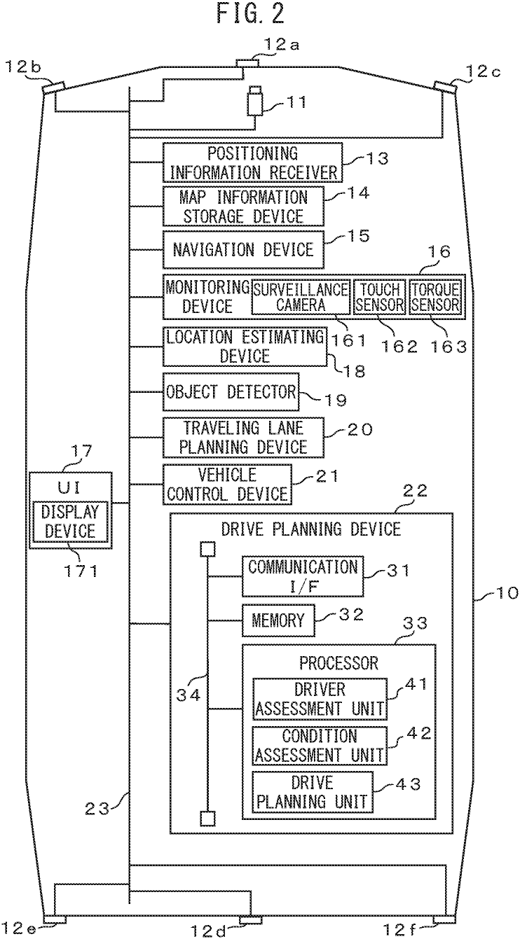

FIG. 2 is a general schematic drawing of a vehicle 10 in which a drive planning device 22 is mounted. The vehicle 10 has a camera 11, radar sensors 12a to 12e, a positioning information receiver 13, a map information storage device 14, a navigation device 15, a monitoring device 16, a user interface (UI) 17, a location estimating device 18, an object detector 19, a traveling lane planning device 20, a vehicle control device 21 and a drive planning device 22. The vehicle 10 may also have a LiDAR sensor to detect road features or other objects.

The camera 11, radar sensors 12a to 12d, positioning information receiver 13, map information storage device 14, navigation device 15, monitoring device 16, user interface (UI) 17, location estimating device 18, object detector 19, traveling lane planning device 20, vehicle control device 21 and drive planning device 22 are connected in a communicable manner through an in-vehicle network 23 that conforms to controller area network standards.

The camera 11 is an example of an imaging unit provided in the vehicle 10. The camera 11 is mounted inside the vehicle 10 and directed toward the front of the vehicle 10. The camera 11, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The camera 11 has a 2D detector composed of an array of photoelectric conversion elements with visible light sensitivity, such as a CCD or C-MOS, and an imaging optical system that forms an image of the photographed region on the 2D detector.

Each time a camera image is taken, the camera 11 outputs the camera image and the camera image photograph time at which the camera image was taken, through the in-vehicle network 23 to the location estimating device 18 and object detector 19. The camera image is also used for processing at the location estimating device 18 to estimate the location of the vehicle 10. At the object detector 19, the camera image is used for processing to detect other objects surrounding the vehicle 10.

The radar sensors 12a to 12f are mounted on the outer sides of the vehicle 10, for example, being directed toward the front, left front side, right front side, rear, left rear side and right rear side of the vehicle 10, respectively. The radar sensors 12a to 12f respectively synchronize and emit millimeter waves toward the front, left front, right front, rear, left rear and right rear of the vehicle 10, at a reflected wave information acquisition time set with a predetermined cycle, and receive a reflected wave that has been reflected from a reflector. The time required for the reflected wave to return contains information for the distance between the vehicle 10 and other objects located in the direction in which the millimeter waves have been emitted. Each of the radar sensors 12a to 12f outputs the reflected wave information that includes the millimeter wave emission direction and the time required for the reflected wave to return, together with the reflected wave information acquisition time at which the millimeter waves were emitted, through the in-vehicle network 23 to the object detector 19. At the object detector 19, the reflected wave information is used for processing to detect other objects surrounding the vehicle 10.

The positioning information receiver 13 outputs positioning information that represents the current location of the vehicle 10. The positioning information receiver 13 may be a GNSS receiver, for example. The positioning information receiver 13 outputs positioning information and the positioning information acquisition time at which the positioning information has been acquired, to the map information storage device 14 and navigation device 15, each time positioning information is acquired at a predetermined receiving cycle.

The map information storage device 14 stores wide-area map information for a relatively wide area (an area of 10 to 30 km², for example) that includes the current location of the vehicle 10. The wide-area map information preferably has high precision map information including three-dimensional information for the road surface, information for the types and locations of structures and road features such as road lane marking lines, and the legal speed limit for the road. The map information storage device 14 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 13, the map information storage device 14 refers to the stored wide-area map information and outputs map information for a relatively narrow area including the current location represented by the positioning information (for example, an area of 100 m to 10 km²), through the in-vehicle network 23 to the location estimating device 18, the traveling lane planning device 20 and the drive planning device 22.

Based on the navigation map information, the destination location of the vehicle 10 input through the UI 17, and positioning information representing the current location of the vehicle 10 input from the positioning information receiver 13, the navigation device 15 creates a traveling route from the current location to the destination location of the vehicle 10. The traveling route includes information relating to the locations of right turns, left turns, merging and branching. When the destination location has been newly set or the current location of the vehicle 10 has exited the traveling route, the navigation device 15 creates a new traveling route for the vehicle 10. Every time a traveling route is created, the navigation device 15 outputs the traveling route to the location estimating device 18 via the in-vehicle network 23.

The monitoring device 16 monitors the state of the driver, and when activity of the driver related to driving has not been detected, it generates a “non-active driving signal”, indicating that activity of the driver relating to driving has not been detected. The monitoring device 16 outputs the non-active driving signal to the drive planning device 22 via the network 23. The monitoring device 16 comprises a surveillance camera 161 that photographs a head image that includes the head of the driver, a touch sensor 162 that detects when the driver is holding the steering wheel, and a torque sensor 163 that detects the torque of the steering wheel. Based on an image of the head photographed at a monitoring time with a predetermined cycle, the monitoring device 16 detects the driver’s line-of-sight direction, the degree to which the eyes are open (hereunder also referred to as “degree of eye opening”) and the degree to which the mouth is open (hereunder also referred to as “degree of mouth opening”), and assesses the level to which the driver is active in operating the vehicle, based on the detected line-of-sight direction, degree of eye opening and degree of mouth opening. When the line-of-sight direction is out of a predetermined range that includes the front of the vehicle 10, the monitoring device 16 assesses that the level of active operation by the driver is low. When the degree of eye opening is less than a predetermined reference value for the degree of eye opening or the degree of mouth opening is greater than a predetermined reference value for the degree of mouth opening, the monitoring device 16 likewise assesses that the level of active operation by the driver is low. On the other hand, when the line-of-sight direction is within a predetermined range including the front of the vehicle 10, or the degree of eye opening is greater than a predetermined reference value for the degree of eye opening, or the degree of mouth opening is less than a predetermined reference value for the degree of mouth opening, the monitoring device 16 assesses that the level of active operation by the driver is high.

When it has been assessed that the level of active operation by the driver is low, the monitoring device 16 alerts the driver through the UI 17 to recommend active operation of the vehicle. If, within a predetermined time after having alerted the driver, it has been assessed that the level of active operation by the driver is high based on the detected line-of-sight direction, degree of eye opening and degree of mouth opening, the monitoring device 16 assesses that the driver is actively operating the vehicle. If, within a predetermined time after having alerted the driver, the touch sensor 162 has detected that the driver is holding the steering wheel, or the torque sensor 163 has detected operation of the steering wheel by the driver, the monitoring device 16 assesses that the driver is actively operating the vehicle. If, within a predetermined time after having alerted the driver, operation of the accelerator pedal or brake pedal by the driver has been detected, the monitoring device 16 assesses that the driver is actively operating the vehicle. On the other hand, when it has not been assessed that the level of active operation by the driver is high, and the touch sensor 162 has not detected that the driver is holding the steering wheel, and the torque sensor 163 has not detected operation of the steering wheel by the driver, and operation of the accelerator pedal or brake pedal by the driver has not been detected, within a predetermined time after having alerted the driver, then it is assessed that the driver is not actively operating the vehicle. The monitoring device 16 also generates a non-active driving signal indicating that activity related to operation by the driver has not been detected. This is only one example of generating a non-active driving signal, and the monitoring device 16 may use another method to assess whether or not a non-active driving signal is to be generated. Moreover, in the example described above, a single alert is sent to the driver before generating the non-active driving signal, but the monitoring device 16 may send multiple alerts or may generate the non-active driving signal without sending an alert.

The UI 17 is an example of the notification unit. The UI 17 is controlled by the navigation device 15, monitoring device 16 and drive planning device 22 to give the driver traveling information for the vehicle 10 and alerts for recommending active operation. The UI 17 also creates an operation signal in response to operation of the vehicle 10 by the driver. The traveling information of the vehicle 10 includes information relating to the location of the vehicle and the current and future route of the vehicle, such as the traveling route. The UI 17 has a display device 171 such as a liquid crystal display or touch panel, for display of the traveling information and alerts. The UI 17 may also have an acoustic output device (not shown) to notify the driver of traveling information and alerts. The UI 17 also has a touch panel or operating button, for example, as an input device for inputting operation information from the driver to the vehicle 10. The operation information may be, for example, a destination location, transit points, vehicle speed or other vehicle control information. The UI 17 outputs the input operation information to the navigation device 15 and the drive planning device 22, via the in-vehicle network 23.

The location estimating device 18 estimates the location of the vehicle 10 at the camera image photograph time, based on the road features surrounding the vehicle 10 represented in the camera image. For example, the location estimating device 18 compares lane marking lines identified in the camera image with lane marking lines represented in the map information input from the map information storage device 14, and determines the estimated location and estimated declination of the vehicle 10 at the camera image photograph time. The location estimating device 18 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 18 outputs this information to the object detector 19, traveling lane planning device 20, vehicle control device 21 and drive planning device 22.

The object detector 19 detects other objects around the vehicle 10 and their types (for example, vehicles) based on the camera image and reflected wave information. Other objects also include other vehicles traveling around the vehicle 10. The object detector 19 tracks other detected objects and determines the trajectories of the other objects. In addition, the object detector 19 identifies the traveling lanes in which the other objects are traveling, based on the lane marking lines represented in the map information and the locations of the objects. The object detector 19 also identifies shoulders in which other objects may be traveling, based on the division lines dividing the traffic lane and shoulders as represented in the map information, and the locations of other objects. The object detector 19 outputs object detection information which includes information representing the types of other objects that were detected, information indicating their locations, and also information indicating their traveling lanes or shoulders in which they are traveling, to the traveling lane planning device 20 and drive planning device 22.

At a traveling lane-planning creation time set in a predetermined cycle, the traveling lane planning device 20 selects a traffic lane on the road on which the vehicle 10 is traveling, within the nearest driving zone (for example, 10 km) selected from the traveling route as input from the navigation device 15, based on the map information, the traveling route and surrounding environment information and the current location of the vehicle 10, and creates a traveling lane plan representing the scheduled traveling lane for traveling of the vehicle 10. For example, the traveling lane planning device 20 creates a traveling lane plan for the vehicle 10 to travel on a traffic lane other than a passing traffic lane. Each time a traveling lane plan is created, the traveling lane planning device 20 outputs the traveling lane plan to the drive planning device 22.

The traveling lane planning device 20 also assesses whether or not a lane change is necessary within the nearest driving zone selected from the traveling route, based on the map information, the traveling route and the current location of the vehicle 10. The traveling lane planning device 20 may further utilize surrounding environment information or vehicle status information for assessment of whether or not a lane change is necessary. The surrounding environment information includes the locations and speeds of other vehicles traveling around the vehicle 10. The vehicle status information includes the current location of the vehicle 10, and the vehicle speed, acceleration and traveling direction. Specifically, the traveling lane planning device 20 assesses whether or not a lane change is necessary for moving to a traffic lane toward the destination location of the vehicle 10, based on the traveling route and the current location of the vehicle 10. Assessment is made of whether or not the vehicle 10 is approaching another road that merges ahead from the traveling route on which it is currently traveling (merge), or the vehicle 10 is exiting onto another road branching ahead from the traveling route (branch). Since merging and branching involve movement of the vehicle from a lane of the traveling route to a lane in another road, they include lane changes.

The vehicle control device 21 controls each unit of the vehicle 10 based on the location of the vehicle 10 and the vehicle speed and yaw rate, as well as on the driving plan, so that the vehicle 10 travels along the traveling route. For example, the vehicle control device 21 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 21 also outputs a control signal corresponding to a set steering amount, to an actuator (not shown) that controls the steering wheel for the vehicle 10. The vehicle control device 21 also determines the amount of fuel injection according to a set accelerator level, and outputs a control signal corresponding to the amount of fuel injection to a drive unit (not shown) of the engine of the vehicle 10. Alternatively, the vehicle control device 21 may output a control signal corresponding to a set brake level to the brake (not shown) of the vehicle 10.

All or some of the functions of the location estimating device 18, object detector 19, traveling lane planning device 20 and vehicle control device 21 are carried out by functional modules executed by a computer program operating on a processor, for example. Alternatively, all or some of the functions of the location estimating device 18, object detector 19, traveling lane planning device 20 and vehicle control device 21 may be carried out by specialized computing circuits. The location estimating device 18, object detector 19, traveling lane planning device 20, vehicle control device 21 and drive planning device 22 were explained above as separate devices, but all or some of them may be constructed in a single device.

The drive planning device 22 carries out driver assessment processing in which it assesses whether or not there is a problem with the driver. The drive planning device 22 also carries out condition assessment processing in which it assesses whether or not a predetermined condition has been met, based on information for the surrounding environment of the vehicle.

At a driving plan creation time set with a predetermined cycle, the drive planning device 22 carries out driving plan processing in which it creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The drive planning device 22 also carries out driving plan processing in which it generates a driving plan to move the vehicle 10 to the shoulder and stop it, when it has assessed that there is a problem with the driver and has assessed that the predetermined condition has been met. The drive planning device 22 also alternatively carries out driving plan processing in which it generates a driving plan to stop the vehicle 10 in the traffic lane in which the vehicle 10 is traveling, when it has assessed that there is a problem with the driver and has assessed that the predetermined condition has not been met.

The driving plan is represented as a combination of the target location of the vehicle 10 and the target vehicle speed at the target location, at each time from the current time until the predetermined time. The cycle in which the driving plan is created is preferably shorter than the cycle in which the traveling lane plan is created. When the traveling lane plan includes a lane change wherein the vehicle 10 is to move between traffic lanes or between a traffic lane and the shoulder, the drive planning device 22 creates a driving plan that includes the lane change, in such a manner that a predetermined distance can be maintained between the vehicle 10 and other vehicles. When the traveling lane plan includes a lane change wherein the vehicle 10 is to move between traffic lanes, but a predetermined distance cannot be ensured between the vehicle 10 and another vehicle, the drive planning device 22 creates a driving plan for stopping the vehicle. The drive planning device 22 outputs a driving plan to the vehicle control device 21 for each driving plan created.

The communication IF 31 is an example of an in-vehicle communication unit, and it has an interface circuit to connect the drive planning device 22 with the in-vehicle network 23. That is, the communication IF 31 is connected with the camera 11, radar sensors 12a to 12d, positioning information receiver 13, map information storage device 14, navigation device 15, monitoring device 16, UI 17, location estimating device 18, object detector 19, traveling lane planning device 20 and vehicle control device 21, via the in-vehicle network 23.

The memory 32 is an example of a memory unit, and it has a volatile semiconductor memory and a non-volatile semiconductor memory, for example. The memory 32 stores an application computer program and various data to be used for information processing carried out by the processor 33 of the drive planning device 22.

The processor 33 comprises one or more CPUs (Central Processing Units) and their peripheral circuits. The processor 33 may also have other computing circuits such as a logical operation unit, numerical calculation unit or graphic processing unit. When the processor 33 has multiple CPUs, it may have a separate memory for each CPU. The processor 33 carries out driver assessment processing, condition assessment processing and driving plan processing.

The processor 33 comprises a driver assessment unit 41 that carries out the driver assessment processing, a condition assessment unit 42 that carries out the condition assessment processing and a drive planning unit 43 that carries out the driving plan processing. Each of the units of the processor 33 are functional modules driven by a computer program operating on the processor 33, for example. Alternatively, each of the units of the processor 33 may be specialized computing circuits in the processor 33.

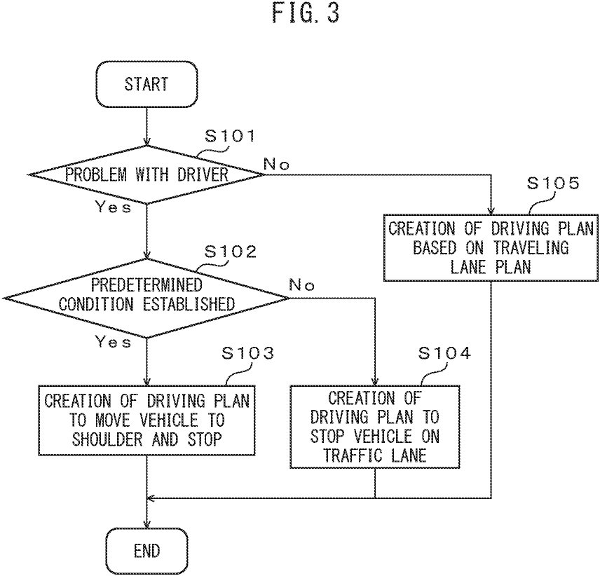

FIG. 3 is an example of an operation flow chart for the drive planning device 22. Processing for creating a driving plan by the drive planning device 22 will now be described in detail with reference to FIG. 3. The drive planning device 22 repeatedly carries out driving plan processing according to the operation flow chart shown in FIG. 3, while the vehicle 10 is traveling.

First, the driver assessment unit 41 of the processor 33 of the drive planning device 22 assesses whether or not there is a problem with the driver at a driver assessment time set at a predetermined cycle (step S101). When a non-active driving signal has been input from the monitoring device 16, indicating that active operation of the vehicle by the driver has not been detected, the driver assessment unit 41 assesses that there is a problem with the driver (step S101 - Yes). When a non-active driving signal has not been input from the monitoring device 16, on the other hand, the driver assessment unit 41 assesses that there is no problem with the driver.

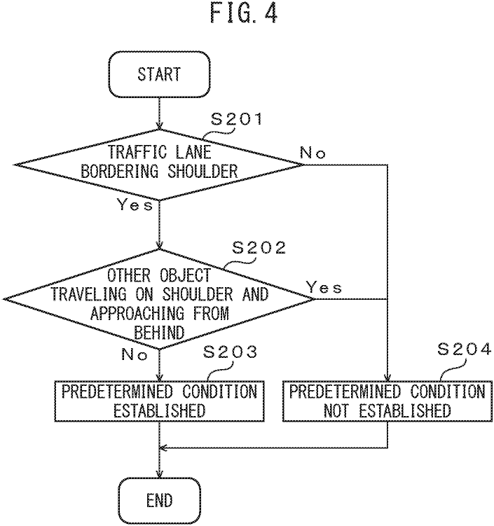

When it has been assessed that there is a problem with the driver, the condition assessment unit 42 of the processor 33 of the drive planning device 22 assesses whether or not predetermined condition has been met (step S102). Determining whether or not the predetermined condition has been met in step S102 will be described below with reference to FIG. 4.

When it has been assessed that the predetermined condition has been met (step S102 -Yes), the drive planning unit 43 of the processor 33 of the drive planning device 22 creates a driving plan for moving the vehicle 10 to the shoulder and stopping it (step S103) (see FIG. 1A). When it has been assessed that the predetermined condition has not been met (step S102 - No), on the other hand, the drive planning unit 43 creates a driving plan for stopping the vehicle 10 in the traffic lane in which the vehicle 10 is traveling (step S104) (see FIG. 1B). The drive planning unit 43 carries out the operation shown in FIG. 3, until the vehicle control unit 21 initiates control to either cause the vehicle 10 to travel toward a target location on the shoulder 53 based on the driving plan, or to cause the vehicle 10 to stop in the traffic lane in which the vehicle 10 is traveling.

When it has been assessed that there is no problem with the driver, the drive planning unit 43 creates a driving plan based on the traveling lane plan (step S105). Specifically, the drive planning unit 43 creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information.

With this processing it is possible to create a driving plan for the vehicle, so that the vehicle 10 is moved to the shoulder and stopped when there is a problem with the driver, only if the predetermined condition has been met that are estimated to allow the safety of the vehicle 10 to be ensured. This allows a driving plan to be created for safely stopping the vehicle even when the shoulder where traveling is normally not permitted and is considered to be safe, is not safe due to the conditions (as traveling on the shoulder is sometimes permitted at predetermined times or under certain conditions depending on the road situation, as established by country).

FIG. 4 is an example of an operation flow chart for the condition assessment unit, to determine whether or not predetermined conditions are met.

First, the condition assessment unit 42 assesses whether or not the vehicle 10 is traveling in a traffic lane bordering a shoulder, based on the current location of the vehicle 10 and on map information (step S201).

When it has been assessed that the vehicle 10 is traveling in a traffic lane bordering a shoulder (step S201 - Yes), the condition assessment unit 42 assesses whether or not another object has been detected traveling on the shoulder and approaching the vehicle 10 from behind the vehicle 10, based on object detection information input from the object detector 19 (step S202).

When the vehicle 10 is traveling on a traffic lane bordering a shoulder and another object has not been detected traveling on the shoulder and approaching the vehicle 10 from behind the vehicle 10 (step S202 - No), then it is assessed that the predetermined condition has been met.

When it has been assessed that the vehicle 10 is not traveling on a traffic lane bordering a shoulder (step S201 - No), on the other hand, or when another object has been detected traveling on the shoulder and approaching the vehicle 10 from behind the vehicle 10 (step S202 -Yes), the condition assessment unit 42 assesses that the predetermined condition has not been met (step S204).

In the example shown in FIG. 4, it was assessed that the predetermined conditions were met (step S102 in FIG. 3) based on surrounding information of the vehicle 10, including that (1) the vehicle 10 is traveling on a traffic lane bordering a shoulder, and (2) no objects are detected traveling on the shoulder and approaching the vehicle 10 from behind the vehicle 10. However, in addition to the surrounding information of (1) and (2) for assessing whether the predetermined conditions are met, the following other surrounding information and one or more from among the following (3) to (14) may also be used as information for the vehicle 10.

### Other Surrounding Information

(3) There is no approach within a predetermined distance to a merging point where the road on which the vehicle 10 is traveling merges with another road;
(4) no obstacles are detected on the scheduled traveling trajectory created by the drive planning device 22;
(5) the current location of the vehicle 10 is not outside of the region represented by high precision map information stored in the map information storage device.

### Vehicle Information for Vehicle 10

(6) The brake pedal (not shown) has been operated;
(7) the operating mode in which operation of the vehicle 10 is controlled by automatic control has been canceled;
(8) a switch has been operated, which is controlled to place the parking brake on, in linkage with operation of the shift position to parking;
(9) the shift position has been moved to the neutral position;
(10) braking control has been carried out due to detection of another object;
(11) an abnormality has been detected by devices used for assessment and operation for moving the vehicle 10 to the shoulder, such as the radar sensors 12a to 12f and camera 11;
(12) the vehicle 10 has continuously traveled a predetermined distance or the vehicle 10 has traveled continuously during a predetermined time;
(13) the current location of the vehicle 10 has deviated for at least a predetermined distance in the direction perpendicular to the traveling direction in the scheduled traveling trajectory created by the drive planning device 22;
(14) an abnormality has been detected by the location estimating device 18.

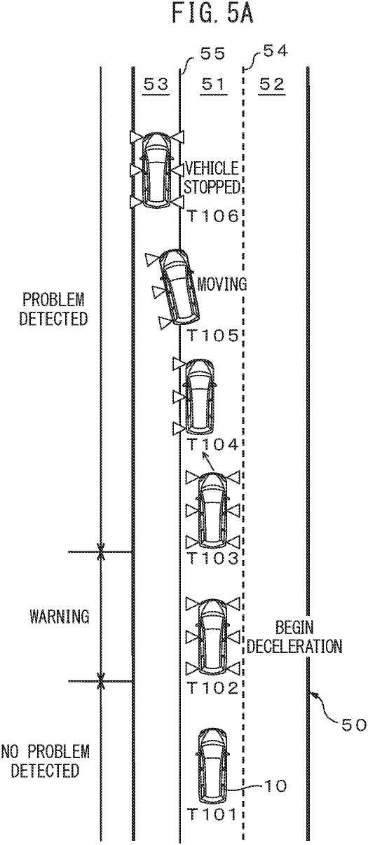

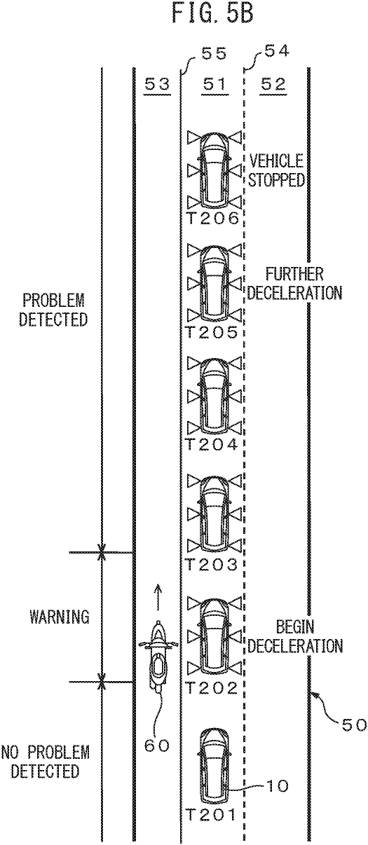

An example of operating the vehicle 10 controlled based on the driving plan described above will now be explained with reference to FIG. 5A and FIG. 5B. FIG. 5A corresponds to FIG. 1A, and FIG. 5B corresponds to FIG. 1B. In FIG. 5A and FIG. 5B, flashing of emergency flash display indicators of the vehicle 10 is added to FIG. 1A and FIG. 1B.

An example of the vehicle 10 being automatically controlled, based a driving plan for moving the vehicle 10 to the shoulder and stopping it, will now be explained using FIG. 5A. First, at time T101, the vehicle 10 travels on the traffic lane 51 of the road 50 and the monitoring device 16 of the vehicle 10 assesses that the driver is actively operating the vehicle.

Next, at time T102, since it has been assessed by the monitoring device 16 that the level of active operation by the driver is low, it gives the driver an alert through the UI 17 to actively operate the vehicle. The monitoring device 16 also outputs a signal indicating a low level of active operation by the driver, to the drive planning device 22 via the in-vehicle network 23, and in response, the drive planning device 22 causes flashing of the emergency flash indicator and begins deceleration. This provides a warning to those around the vehicle 10 to be wary of the behavior of the vehicle 10.

At time T103, the monitoring device 16 has not assessed that the level of active operation by the driver is high, the touch sensor 162 has not detected that the driver is holding the steering wheel, the torque sensor 163 has not detected operation of the steering wheel by the driver and operation of the accelerator pedal or brake pedal by the driver has not been detected, within a predetermined time after having alerted the driver, and therefore a non-active driving signal is generated indicating that active operation by the driver has not been detected. The monitoring device 16 outputs the non-active driving signal to the drive planning device 22 via the in-vehicle network 23. Since a non-active driving signal has been input from the monitoring device 16, the driver assessment unit 41 of the drive planning device 22 assesses that there is a problem with the driver. The drive planning device 22 therefore continuously flashes the emergency flash indicator of the vehicle 10.

The condition assessment unit 42 of the drive planning device 22 assesses that the vehicle 10 is traveling in a traffic lane 51 that borders a shoulder 53, based on the current location of the vehicle 10 and on map information. The condition assessment unit 42 of the drive planning device 22 also assesses that no other object has been detected traveling on the shoulder 53 and approaching the vehicle 10 from behind the vehicle 10. Based on this assessment, that the predetermined condition has been met, the drive planning unit 43 of the drive planning device 22 sets a target location on the shoulder 53 where the vehicle 10 can stop, based on the current location of the vehicle 10, the map information and the speed of the vehicle 10. The drive planning unit 43 creates a driving plan so that the vehicle is stopped while decelerating toward the target location. The drive planning unit 43 carries out the assessment processing shown in FIG. 3, until the vehicle control unit 21 initiates control to cause the vehicle 10 to travel toward a target location on the shoulder 53 based on the driving plan. Even after the drive planning unit 43 has created a driving plan to move the vehicle 10 toward the target location on the shoulder 53, if an obstacle has been detected on the scheduled traveling trajectory before the vehicle control unit 21 has begun control of the vehicle 10 based on the driving plan, then it sets a new target location on the shoulder 53 and creates a driving plan to move the vehicle 10 toward the new target location on the shoulder 53. Even after the drive planning unit 43 has created a driving plan to move the vehicle 10 toward the target location on the shoulder 53, if it has been assessed that another object was detected traveling on the shoulder 53 approaching the vehicle 10 from behind the vehicle 10 before the vehicle control unit 21 has begun control of the vehicle 10 based on the driving plan, then it assesses that the predetermined condition has not been met.

If the vehicle 10 reaches a predetermined distance from the target location on the shoulder 53 at time T104, then the vehicle speed is decelerated to a predetermined speed (such as 10 km/h). The vehicle 10 moves to the shoulder 53 side and travels along the shoulder 53, in the traffic lane 51 in which the vehicle 10 is traveling. For example, the drive planning unit 43 creates a driving plan so that the vehicle 10 travels at a location separated by about 30 to 50 cm from the division line dividing the traffic lane and the shoulder. This allows other vehicles surrounding the vehicle 10 to be alerted that the vehicle 10 will move to the shoulder. The vehicle 10 flashes a direction indicator while traveling on the traffic lane 51 for a predetermined distance along the shoulder 53, toward a target location on the shoulder 53. Incidentally, the vehicle 10 does not flash the emergency flash indicator while it flashes the direction indicator.

Next, at time T105, the vehicle 10 begins to move to the shoulder 53, toward the target location on the shoulder 53, while maintaining a predetermined distance between the vehicle 10 and other vehicles. The vehicle 10 enters the shoulder 53 from the traffic lane 51 on which it was traveling, while straddling the division line 55.

Finally, at time T106, the vehicle 10 stops at the target location on the shoulder 53, and the drive planning device 22 resumes flashing of the emergency flash indicator of the vehicle 10. When moving to the target location, the vehicle 10 may be automatically controlled for an emergency stop if an obstacle has been detected on the scheduled traveling trajectory.

An example of the vehicle 10 being automatically controlled, based a driving plan for stopping the vehicle 10 in the traffic lane in which the vehicle 10 is traveling, will now be explained using FIG. 5B. Operation of the vehicle 10 at time T201 and time T202, and operation until the non-active driving signal is output to the drive planning device 22 from the monitoring device 16 at time T203, are the same as shown for time T101 to time T103 in FIG. 5A.

At time T203, the condition assessment unit 42 of the drive planning device 22 assesses that the vehicle 10 is traveling in a traffic lane 51 that borders a shoulder 53, based on the current location of the vehicle 10 and on map information. Since another vehicle 60 is traveling on the shoulder 53 from behind and approaching the vehicle 10, the condition assessment unit 42 of the drive planning device 22 also assesses that another object has been detected traveling on the shoulder 53 and approaching the vehicle 10 from behind the vehicle 10. Based on this assessment, that the predetermined condition has not been met, the drive planning unit 43 of the drive planning device 22 sets a target location on the traffic lane 51 where the vehicle 10 is to stop, based on the current location of the vehicle 10, the map information and the speed of the vehicle 10. The drive planning unit 43 generates a driving plan so that the vehicle is stopped while decelerating toward the target location. The drive planning unit 43 carries out the assessment processing shown in FIG. 3, until the vehicle control unit 21 initiates control to cause the vehicle 10 to travel toward a target location on the shoulder 53 based on the driving plan. In some cases, another object may pass beside the vehicle 10 even after the drive planning unit 43 has created a driving plan for stopping the vehicle 10 in the traffic lane in which the vehicle 10 is traveling, but before the vehicle control unit 21 begins control of the vehicle 10 based on the driving plan. Since the other object is no longer detected traveling on the shoulder 53 and approaching the vehicle 10 from behind the vehicle 10 in such cases, the drive planning unit 43 assesses that the predetermined condition has been met. It also sets the target location for stopping the vehicle 10 on the shoulder 53 and creates a driving plan to move it to the shoulder 53 toward the target location.

Next, when the vehicle 10 reaches a predetermined distance from the target location on the traffic lane 51 at time T204 and time T205, it decelerates to a predetermined speed (such as 10 km/h) and moves on the traffic lane 51 to the target location.

Finally, at time T206, the vehicle 10 stops at the target location on the traffic lane 51. When even one other vehicle has been detected traveling on the shoulder 53 and approaching from behind the vehicle 10, this raises the possibility of yet another vehicle traveling on the shoulder 53, and therefore a driving plan for withdrawing again to the shoulder 53 is not created after stopping at the target location on the traffic lane 51. The drive planning device 22 also continuously flashes the emergency flash indicator of the vehicle 10 during the period from time T202 to time T206.

As explained above, the drive planning device assesses whether or not there is a problem with the driver, to assess whether or not a predetermined condition has been met based on information for the surrounding environment of the vehicle, and when it has been assessed that there is a problem with the driver and the predetermined condition has been met, it creates a first driving plan in which the vehicle is moved to the shoulder and stopped, or when it has been assessed that there is a problem with the driver and it has been assessed that the predetermined condition has not been met, it creates a second driving plan in which the vehicle is stopped in the traffic lane in which the vehicle is traveling. The drive planning device can thus create a driving plan for the vehicle, so that the vehicle 10 is moved to the shoulder and stopped when there is a problem with the driver only if the predetermined condition has been met that is estimated to allow the safety of the vehicle 10 to be ensured.

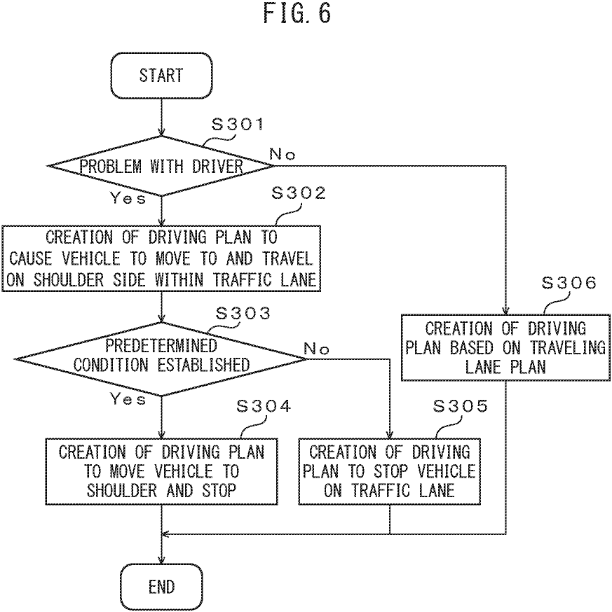

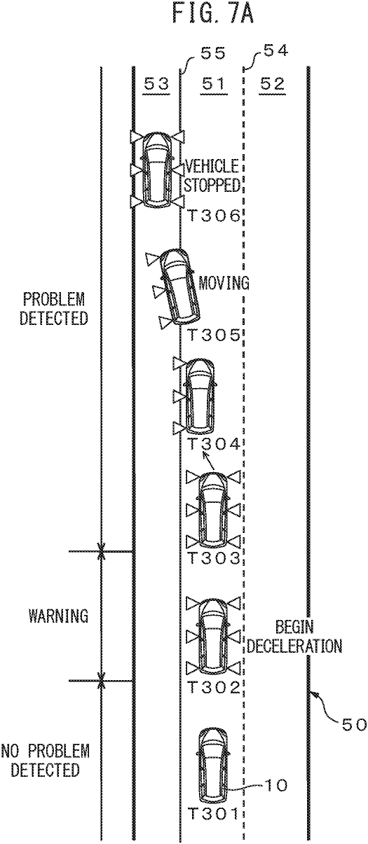

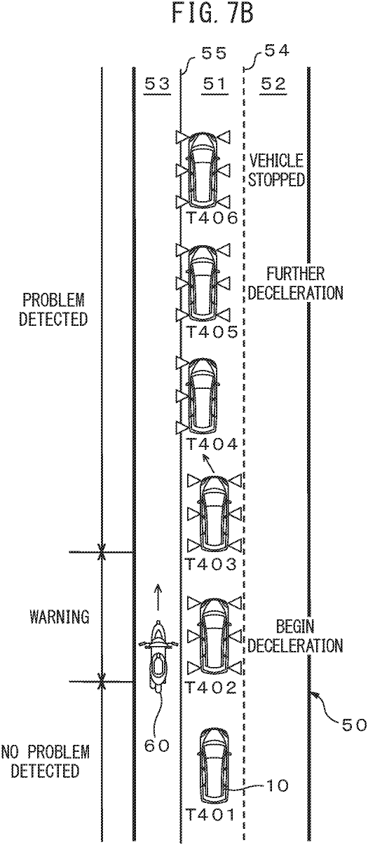

The second embodiment of the drive planning device will now be described with reference to FIG. 6 and FIG. 7. Similar reference numerals will be used for components of the second embodiment that correspond to those of the first embodiment, and they will not be explained again.

FIG. 6 is an example of an operation flow chart for a drive planning device of the second embodiment. Operation of the drive planning device of the second embodiment will now be explained with reference to the operation flow chart shown in FIG. 6. For the second embodiment, an operation of first moving the vehicle to the shoulder side within the traveling lane is added to the operation of the first embodiment in either case, whether the vehicle moves to the shoulder or whether it stops on the traveling lane.

The processing of step S301 is the same as step S101 of FIG. 3, and will not be explained again here.

When it has been assessed that there is a problem with the driver (step S301 - Yes), the drive planning unit 43 of the processor 33 of the drive planning device 22 creates a driving plan for moving the vehicle to the shoulder side and causing it to travel within the traffic lane in which the vehicle 10 is traveling (step S302). The drive planning unit 43 generally creates a driving plan so that vehicle 10 travels in the center of the traffic lane in which it is traveling. When it has been assessed that there is a problem with the driver, however, the drive planning unit 43 creates a driving plan for the vehicle 10 to travel along the shoulder side rather than the center of the traffic lane in which it is traveling. For example, the drive planning unit 43 creates a driving plan so that the vehicle 10 travels at a location separated by about 30 to 50 cm from the division line dividing the traffic lane and the shoulder. This allows other vehicles surrounding the vehicle 10 to be alerted to the possibility that the vehicle 10 may move to the shoulder.

The processing of step S303 to step S306 is the same as the processing of step S102 to step S105 of FIG. 3, and will not be explained again here.

An example of operating the vehicle that is controlled based on the driving plan described above will now be explained with reference to FIG. 7A and FIG. 7B. FIG. 7A corresponds to FIG. 5A, and FIG. 7B corresponds to FIG. 5B.

An example of the vehicle 10 being automatically controlled, based a driving plan for moving the vehicle 10 to the shoulder and stopping it, will now be explained using FIG. 7A.

Operation of the vehicle 10 at time T301 and time T302, and operation until the non-active driving signal is output to the drive planning device 22 from the monitoring device 16 at time T303, are the same as shown for time T101 to time T103 in FIG. 5A.

Since a non-active driving signal has been input from the monitoring device 16 at time T303, the driver assessment unit 41 of the drive planning device 22 assesses that there is a problem with the driver. Therefore, the drive planning device 22 continues flashing of the emergency flash indicator of the vehicle 10, and provides a warning to those around the vehicle 10 be wary of the behavior of the vehicle 10. The drive planning unit 43 of the drive planning device 22 also creates a driving plan for moving the vehicle 10 within the traffic lane 51 in which the vehicle is traveling, and causing it to travel on the shoulder 53 side.

Next, at time T304, the vehicle 10 is caused to flash the direction indicator of the vehicle 10 and move to the shoulder 53 side within the traffic lane 51 while maintaining a predetermined distance between the vehicle 10 and other vehicles, traveling on the traffic lane 51 while decelerating. Incidentally, the emergency flash indicator does not flash while the direction indicator is flashing.

The condition assessment unit 42 of the drive planning device 22 also assesses that the vehicle 10 is traveling in a traffic lane 51 that borders a shoulder 53, based on the current location of the vehicle 10 and on map information. The condition assessment unit 42 of the drive planning device 22 also assesses that no other object has been detected traveling on the shoulder 53 and approaching the vehicle 10 from behind the vehicle 10. Based on this assessment, that the predetermined condition has been met, the drive planning unit 43 of the drive planning device 22 sets a target location on the shoulder 53 where the vehicle 10 can stop, based on the current location of the vehicle 10, the map information and the speed of the vehicle 10. The drive planning unit 43 creates a driving plan so that the vehicle is stopped while decelerating toward the target location.

Operation of the vehicle 10 from time T305 to time T306 is the same as from time T105 to time T106 in FIG. 5A, and it will not be explained in detail again here.

An example of the vehicle 10 being automatically controlled, based a driving plan for stopping the vehicle 10 in the traffic lane in which the vehicle 10 is traveling, will now be explained using FIG. 7B.

Operation of the vehicle 10 from time T401 to time T403 is the same as from time T301 to time T303 in FIG. 7A.

At time T404, the vehicle 10 is caused to flash the direction indicator of the vehicle 10 and move to the shoulder 53 side within the traffic lane 51 while ensuring a predetermined distance between the vehicle 10 and other vehicles, traveling on the traffic lane 51 while decelerating. The emergency flash indicator does not flash while the direction indicator is flashing.

The condition assessment unit 42 of the drive planning device 22 assesses that the vehicle 10 is traveling in a traffic lane 51 that borders a shoulder 53, based on the current location of the vehicle 10 and on map information. Since another vehicle 60 is traveling on the shoulder 53 from behind the vehicle 10 and approaching the vehicle 10, the condition assessment unit 42 of the drive planning device 22 also assesses that another object has been detected traveling on the shoulder 53 and approaching the vehicle 10 from behind the vehicle 10. Based on this assessment, that the predetermined condition has not been met, the drive planning unit 43 of the drive planning device 22 creates a driving plan for stopping the vehicle 10 within the traffic lane 51 in which the vehicle 10 is traveling. The drive planning unit 43 sets a target location on the traffic lane 51 where the vehicle 10 is to stop, based on the current location of the vehicle 10, the map information and the speed of the vehicle 10, and creates a driving plan so that it stops while decelerating toward the target location.

Next, at time T405, the vehicle 10 stops flashing the direction indicator and begins flashing the emergency flash indicator. At time T405, with the vehicle 10 kept on the shoulder 53 side within the traffic lane 51, the vehicle 10 moves toward the target location on the traffic lane 51 while decelerating and while maintaining a predetermined distance between the vehicle 10 and other vehicles. The vehicle 10 further decelerates to a stoppable speed before stopping at the target location on the traffic lane 51.

Finally, at time T406, the vehicle 10 stops at the target location on the traffic lane 51.

For the second embodiment described above, an operation of first moving the vehicle to the shoulder side within the traveling lane is added to the operation of the first embodiment in either case, whether the vehicle moves to the shoulder or whether it stops on the traveling lane. Surrounding vehicles, therefore, can be made aware that the vehicle has a problem and can take steps to avoid it.

The drive planning device, the storage medium that stores a computer program for drive planning and the drive planning method of the invention may incorporate appropriate modifications that are within the gist of the invention. Moreover, the technical scope of the invention is not limited to this embodiment, and includes the invention and its equivalents as laid out in the Claims.

1. A drive planning device comprising:
a processor configured to
assess whether there is a problem with a driver,
detect an object approaching behind a vehicle,
assess whether the vehicle is travelling in a traffic lane bordering a shoulder and whether an object traveling the shoulder from behind the vehicle and approaching the vehicle is detected, and
determine a first target stopping location for stopping the vehicle on the shoulder in order to create a first driving plan in which the vehicle is moved to the first target stopping location when it is assessed there is a problem with the driver, and it is assessed that the vehicle is travelling in the traffic lane bordering the shoulder and the object traveling the shoulder from behind the vehicle and approaching the vehicle is not detected, determine a second target stopping location for stopping the vehicle in the traffic lane in which the vehicle is traveling in order to create a second driving plan in which the vehicle is moved to the second target stopping location when it is assessed there is a problem with the driver, and it is assessed that the vehicle is travelling in the traffic lane bordering the shoulder and the object traveling the shoulder from behind the vehicle and approaching the vehicle is detected, and determine a third target stopping location for stopping the vehicle on the shoulder in order to create a third driving plan in which the vehicle is moved to the third target stopping location when it is assessed that the object traveling the shoulder from behind the vehicle and approaching the vehicle is not detected after the second target stopping location has been determined.

2. The drive planning device according to claim 1, wherein the processor is further configured not to create the first driving plan when it is assessed that a predetermined distance between the vehicle and another object is not maintained.

3. The drive planning device according to claim 1, wherein the processor is further configured to create the first driving plan in which the vehicle is moved between traffic lanes when it is assessed that a predetermined distance between the vehicle and another object is maintained.

4. The drive planning device according to claim 1, wherein the processor is further configured to create the third driving plan so that the vehicle begins to move to the third target stopping location ensuring a second predetermined distance is maintained between the vehicle and another vehicle.

5. The drive planning device according to claim 1, wherein the processor is further configured to create the first driving plan so that the vehicle is moved to the first target stopping location and stopped while decelerating toward the first target stopping location.

6. The drive planning device according to claim 1, wherein the processor is further configured to create the first driving plan so that the vehicle is moved to the shoulder and stopped after the vehicle has been moved to the shoulder side in the traffic lane in which the vehicle is traveling and has traveled a predetermined distance along the shoulder when the vehicle is traveling the traffic lane bordering the shoulder.

7. A computer-readable, non-transitory storage medium storing a computer program for creating a driving plan, which causes a processor execute a process, and the process comprising:
assessing whether there is a problem with a driver,
detecting an object approaching behind a vehicle,
assessing whether the vehicle is travelling in a traffic lane bordering a shoulder and whether an object traveling the shoulder from behind the vehicle and approaching the vehicle is detected, and
determining a first target stopping location for stopping the vehicle on the shoulder in order to create a first driving plan in which the vehicle is moved to the first target stopping location when it is assessed there is a problem with the driver, and it is assessed that the vehicle is travelling in the traffic lane bordering the shoulder and the object traveling the shoulder from behind the vehicle and approaching the vehicle is not detected, determining a second target stopping location for stopping the vehicle in the traffic lane in which the vehicle is traveling in order to create a second driving plan in which the vehicle is moved to the second target stopping location when it is assessed there is a problem with the driver, and it is assessed that the vehicle is travelling in the traffic lane bordering the shoulder and the object traveling the shoulder from behind the vehicle and approaching the vehicle is detected, and determining a third target stopping location for stopping the vehicle on the shoulder in order to create a third driving plan in which the vehicle is moved to the third target stopping location when it is assessed that the object traveling the shoulder from behind the vehicle and approaching the vehicle is not detected after the second target stopping location has been determined.

8. A method for creating a driving plan carried out by a drive planning device, and the method comprising:
assessing whether there is a problem with a driver,
detecting an object approaching behind a vehicle,
assessing whether the vehicle is travelling in a traffic lane bordering a shoulder and whether an object traveling the shoulder from behind the vehicle and approaching the vehicle is detected, and
determining a first target stopping location for stopping the vehicle on the shoulder in order to create a first driving plan in which the vehicle is moved to the first target stopping location when it is assessed there is a problem with the driver, and it is assessed that the vehicle is travelling in the traffic lane bordering the shoulder and the object traveling the shoulder from behind the vehicle and approaching the vehicle is not detected, determining a second target stopping location for stopping the vehicle in the traffic lane in which the vehicle is traveling in order to create a second driving plan in which the vehicle is moved to the second target stopping location when it is assessed there is a problem with the driver, and it is assessed that the vehicle is travelling in the traffic lane bordering the shoulder and the object traveling the shoulder from behind the vehicle and approaching the vehicle is detected, and determining a third target stopping location for stopping the vehicle on the shoulder in order to create a third driving plan in which the vehicle is moved to the third target stopping location when it is assessed that the object traveling the shoulder from behind the vehicle and approaching the vehicle is not detected after the second target stopping location has been determined.
